(19) United States
(12) Patent Application Publication
(10) Pub. No.: US 2012/0231326 A1
(43) Pub. Date: Sep. 13, 2012

(54) STRUCTURED SILICON BATTERY ANODES

(75) Inventors: Sibani Lisa Biswal, Houston, TX (US); Michael S. Wong, Houston, TX (US); Madhuri Thakur, Houston, TX (US); Steven L. Sinsbaugh, Bethesda, MD (US); Mark J. Isaacson, Bethesda, MD (US)

(73) Assignees: LOCKHEED MARTIN CORPORATION, Bethesda, MD (US); WILLIAM MARSH RICE UNIVERSITY, Houston, TX (US)

(21) Appl. No.: 13/504,521

(22) PCT Filed: Oct. 28, 2010
(86) PCT No.: PCT/US10/54577

§ 371 Date: Apr. 27, 2012

Related U.S. Application Data
(60) Provisional application No. 61/256,445, filed on Oct. 30, 2009.

(51) Int. Cl. H01M 4/583; H01M 10/04; H01M 2/14; C25F 3/14; H01M 4/38; H01M 2/02; B82Y 40/00; B82Y 30/00; B82Y 99/00

(52) U.S. Cl. 429/163; 429/218.1; 429/220; 429/231.8; 205/665; 977/742; 977/734; 977/773; 977/781; 977/888; 977/755

(57) ABSTRACT

Methods of fabricating porous silicon by electrochemical etching and subsequent coating with a passivating agent process are provided. The coated porous silicon can be used to make anodes and batteries. It is capable of alloying with large amounts of lithium ions, has a capacity of at least 1000 mAh/g and retains this ability through at least 60 charge/discharge cycles. A particular pSi formulation provides very high capacity (3000 mAh/g) for at least 60 cycles, which is 80% of theoretical value of silicon. The Coulombic efficiency after the third cycle is between 95-99%. The very best capacity exceeds 3400 mAh/g and the very best cycle life exceeds 240 cycles, and the capacity and cycle life can be varied as needed for the application.

### CROSS-REFERENCE TO RELATED APPLICATIONS

This patent claims priority to U.S. Provisional Application No. 61/256,445, filed Oct. 30, 2009, and incorporated by reference herein in its entirety.

### FEDERALLY SPONSORED RESEARCH STATEMENT

Not applicable.

### REFERENCE TO MICROFICHE APPENDIX

Not applicable.

### FIELD OF THE INVENTION

This invention relates to method of making porous silicon, and its method of use as a rechargeable battery anode, and to batteries containing same.

### BACKGROUND OF THE INVENTION

In lithium ion batteries, the anode uptakes lithium ions from the cathode when the battery is being charged and releases the lithium ions back to the cathode when the battery is being discharged. One important parameter of the anode material is its capacity to retain lithium ions, since this will directly impact the amount of charge a battery can hold. Another important parameter is cyclability, which is the number of times the material can take up and release lithium ions without degradation or significant loss of capacity. This parameter will directly influence the service life of the battery.

Presently, carbon-based materials (e.g. graphite) are utilized as the anode material in rechargeable batteries.^{1,2} The theoretical capacity limit for intercalation of Li into the carbon is 372 mAh/g, which corresponds to the fully loaded material LiC₆. However, the practical limit is ˜300-330 mAh/g. Consequently, to increase capacity and to meet higher power requirements anticipated for applications like electric vehicles, new materials with higher capacity are necessary. This is an area of active research directed towards new materials such as Si, Sn, Sb, Pb, Al, Zn and Mg etc. and new morphologies.³

Silicon has been widely studied as a promising material for next-generation anodes, due to its extremely high theoretical lithium ion capacity of 4200 mAh/g,⁴ which corresponds to the fully loaded material Li_{4.4}Si. However, silicon has serious expansion/contraction problems during cycling, due to the volumetric change from silicon to lithiated silicon. This greatly increases stress in the crystal structure, leading to pulverization of the silicon. This pulverization leads to increased internal resistance, lower capacity, and battery cell failure.

A variety of silicon structures and silicon-based composites have been examined in order to reduce the lithiation-induced stress and suppress the structural destruction of silicon, which is believed to be the main cause for the loss of sustainability and the lack of capacity retention during charge/discharge cycling.⁵⁻¹¹ Finding an optimal structure/composition of silicon or silicon based materials is a current challenge in the field of battery anode materials research.

One approach being taken by researchers is to consider nanostructured forms of silicon, which have been hypothesized to be more resistant to performance degradation. Others have used nanocomposites consisting of silicon powder and carbon black.¹²⁻¹⁵ These studies used micro-particulate Si or carbon coated silicon. Many of these approaches require expensive vacuum-based manufacturing techniques to create the silicon nanostructure or composite.

The work on Si nanoclusters¹⁶ and Si/graphite nanocomposites¹⁷ showed improvements in the cycle life and lithium capacity as compared to the silicon powder with binder. The improvement of cyclability is due to the nanosize Si particles and their uniform dispersion within the silicon oxide phase retained by the carbon matrix, which could effectively suppress the pulverizing of Si particles by the volume change during lithium insertion and extraction. Si-graphite composites have a higher capacity and cyclability than Si nanoclusters because the silicon particles are uniformly distributed in the graphite matrix resulting in each silicon particle becoming completely covered by multiple graphite layers.

Recent work on silicon nanowires (NWs) have shown improvement in silicon's performance as an anode material,¹⁸⁻²¹ and Si NWs were found to exhibit a higher capacity than other forms of Si.¹¹ The observed charge discharge capacity¹⁸ remained nearly constant at 80% of theoretical value of Si, giving a Coulombic efficiency of 90% with little fading up to 10 cycles, which is considerably better than previously reported results.²²⁻²³ The fading response beyond 10 cycles was not reported, however. Other experiments using carbon-silicon nanowires²¹ show an increase in the cycle stability of the lithium-ion batteries as compared to silicon nanowires¹⁸ due to the carbon support. The carbon support allows very little structure or volume change to occur but there is a trade-off in capacity.

Another example of a silicon nanomaterial is porous silicon (“pSi”), which has been shown to be a promising anode for rechargeable batteries.^{24,25} In this work, the charge capacity is defined as the total charge inserted into the projected electrode surface area exposed to the electrolyte (this ignores any surface area due to structuring), given as μAh·cm⁻². Unfortunately, these groups have not yet been able to successfully prepare pSi-based anodes with both high capacity and long cycle life. The few studies on pSi as a lithium-ion anode material do not report the high performance shown by our materials.

Thus, what is needed in the art is a porous silicon that is cost effective to make and has both high capacity and long cycle life.

### SUMMARY OF THE INVENTION

The use of the word “a” or “an” when used in conjunction with the term “comprising” in the claims or the specification means one or more than one, unless the context dictates otherwise. The term “about” means the stated value plus or minus the margin of error of measurement or plus or minus 10% if no method of measurement is indicated. The use of the term “or” in the claims is used to mean “and/or” unless explicitly indicated to refer to alternatives only or if the alternatives are mutually exclusive. The terms “comprise”, “have”, “include” and “contain” (and their variants) are open-ended linking verbs and allow the addition of other elements when used in a claim.

When discussing pore width and depth herein, what is meant is an average pore width and depth, since there will typically be some variability in these measurements.

The present invention provides an improved anode material comprising coated porous silicon for lithium ion batteries; a lithium ion battery with improved cycling behavior and high capacity, which is 80% of theoretical capacity for 50+ cycles; a low cost method for manufacturing anodes for lithium ion batteries; a reproducible method for making battery anode materials; and a lithium ion battery having substantially higher discharge capacity than present day batteries.

In this invention, we also provide a method to calculate the mass of porous silicon as compared to the bulk silicon. The capacity definition used by prior work²⁴⁻²⁶ is the total charge inserted into the projected electrode surface area exposed to the electrolyte, given as μAhcm⁻² (micro-Amp-hours-cm⁻²). This definition neglects the electrode surface area within the pores, however. In our work, we calculate the charge capacity as the total charge inserted into mass of the surface area, given as mAhg⁻¹ (milli-Amp-hours/gram).

We provide herein a method of fabricating porous silicon by electrochemical etching process that can be done with either acid or plasma. Preferred acids include hydrofluoric acid (HF, usually about 49%), perfluoric, ammonium bifluoride, ammonium fluoride, potassium bifluoride, sodium bifluoride, hydrohalic acids nitric, chromic, sulferic, and the like, as well as mixtures thereof. Particularly preferred are acids such as HF in organic solvents such as DMF, as well as HF in ethanol and HF in acetic acid, etc. Preferred high density plasma's include the plasma gases of SF₆, CF₄, BCl₃, NF₃, XeF₂, and the like as well as mixtures thereof. The etched silicon is then coated with a passivating agent, which appears to prevent silicon degradation on repeated use. A particularly preferred passivating agent is gold applied at 10-100 nm, preferably 20-50 nm, but other passivating agents may also be useful.

The resulting coated porous silicon material is capable of intercalating large amounts of lithium ions and retains this ability through a large number of charge/discharge cycles. We are thus able to significantly improve the anode material, achieving improved cycling behavior and lasting at least 50 cycles with high capacity of at least 1000 mAh/g. With certain pSi formulations, we were able to achieve capacities as high as 3400 mAh/g and a lifespan of at least 200 cycles. Further, it is shown how to maximum either of these important parameters by modifying etch conditions.

More particularly, a method making coated porous silicon is provided wherein flat (wafer) or other 3D forms of silicon are etched under current to produce porous silicon having pores from 10 nm to 10 μm in diameter with an pore depth of 5-100 μm, wherein the silicon is then coated with at least 1 nm of a passivating material to produce a coated porous silicon having a charge capacity of at least 1000 mAh/g for at least 50 cycles.

The silicon can be crystalline silicon, semicrystalline silicon, amorphous silicon, doped silicon, coated silicon, or silicon pretreated by coating with silicon nanoparticles. Current ranges from 1-20 mA, or even as high as 40 mA, and is applied for about 30-300 minutes. The current can be continuous or intermittent and both are exemplified herein. The porosity can be increased by decreasing the concentration of acid and/or increasing the current, and pore size and depth are shown herein to optimize either cycle life or capacity, as needed for the application. The etching can use a high density plasma gas or an acid, and preferably uses HF in DMF in a ratio ranging from 1:5 to 1:35, more particularly 1:5-1:25, or 1:5-1:10. In preferred embodiments, the coating is carbon or gold, preferably at least 5 nm, 10, or 20 nm of gold, or combinations of gold or carbon and other passivating agents can be used. In preferred embodiments the capacity is least 3000 mAh/g or 3400 mAh/g, and the lifespan is at least 100 cycles, 150 cycles, 200 cycles or 250 cycles.

Anodes made from the above etching and coating method are also provided, as are batteries comprising such anodes. The coated porous silicon can be crushed or otherwise comminuted, bound with a matrix material and shaped to form an anode. Alternatively, it can be used as is or be lifted off the bulk silicon and used on a optional substrate with an optional transition layer that is optionally doped. The substrate is selected from the group consisting of copper, bulk silicon, carbon, silicon carbide, carbon, graphite, carbon fibers, graphene sheets, fullerenes, carbon nanotubes, graphene platelets, and the like, and combinations thereof. A rechargeable battery comprising such anodes together with a separator and a cathode material can be packaged in a coil-cell, pouch cell, cylindrical cell, prismatic cell or any other battery configuration.

### BRIEF DESCRIPTION OF THE DRAWINGS

FIG. 1. Schematics of the lithium-ion battery setup with porous silicon as an anode.

FIG. 2. Top (a, c, e, g) and the cross-sectional views (b, d, f, h) of the porous silicon sample at different etching rates: (a,b) sample A; (c,d) sample B; (e,f) sample C; and (g,h) sample D.

FIG. 3A. The voltage profiles for pSi electrode (sample A) at 60 μA between 0.09 to 2V.

FIG. 3B. Capacity versus cycle number for pSi electrode (sample A).

FIG. 4A. The voltage profiles for the pSi electrode (sample B) at 60 μA between 0.09 to 1.5 V.

FIG. 4B. Capacity versus cycle number for the pSi electrode (sample B).

FIG. 5A. The voltage profiles for the pSi electrode (sample C) at 100 μA between 0.11 to 2 V.

FIG. 5B. Capacity versus cycle number for the pSi electrode (sample C).

FIG. 6A. The voltage profiles for the pSi electrode (sample D) at 40 μA between 0.11 to 2.5 V.

FIG. 6B. Capacity versus cycle number for the pSi electrode (sample D).

FIG. 7. The morphology change of pSi structures after electrochemical testing at different cycles: (a,b) the pSi structure (sample A) after 15th cycle; and (c,d) the pSi structure (sample B) after 11th cycle.

FIG. 8. Top (a, c) and the cross-sectional views (b, d) of the porous silicon sample of same depth and different porosity: (a,b) sample E; (c,d) sample F.

FIG. 9. Capacity versus cycle number for the pSi electrode (sample E and sample F).

FIG. 10. Top (a) and cross-sectional views (b) of the porous silicon sample of different depth and same porosity: (a, b) sample G.

FIG. 11. Capacity versus cycle number for the pSi electrode (sample E and G).

FIG. 12. Top (a) and cross-sectional views (b) of the porous silicon with wider pores: (a,b) sample H.

FIG. 13. Capacity versus cycle number of pSi electrode charge and discharge between 0.095 and 1.5 V at 100 μA and 200 μA (sample H).

FIG. 14. The morphology of pSi structures after electrochemical testing at different cycles: (a,b) the pSi structure (sample H) charge and discharge at 200 μA after 230 cycles and (c,d) the pSi structure same sample charge and discharge at 100 μA after 90 cycles.

FIG. 15. Top (a) and cross-sectional views (b) of the porous silicon with Si wafer coated with SiNP before etching: (a,b) sample I.

FIG. 16. Capacity versus cycle number of pSi electrode charge and discharge between 0.11 and 2 V at 100 μA, 150 μA and 200 μA (sample I).

FIG. 17. The morphology of pSi structures after electrochemical testing after 170 cycles: (a,b) sample I.

FIG. 18. Top (a) and backside (b) of lift-off porous silicon.

FIG. 19. Top (a) and cross-sectional views (b) of the porous silicon with deeper pores: (a,b) sample J.

FIG. 20. Capacity versus cycle number of pSi electrode charge and discharge between 0.09 and 1.5 V at 300 μA and 500 μA (sample J).

FIG. 21. The morphology of pSi structures after electrochemical testing after 170 cycles: (a,b) sample J.

### DESCRIPTION OF EMBODIMENTS OF THE INVENTION

The following examples are exemplary only and not intended to be limiting of the various embodiments of the invention.

### EXAMPLE 1

For all experiments, prime grade, boron doped, p-type and single-side polished silicon wafers from Siltronix™ and University™ wafer were used. All the wafers were 275±25 microns thick and had resistivities between 14-22 Ωcm and 10-30 Ωcm with face orientation of (100).

Porous silicon (pSi) was generated by etching crystalline silicon in aqueous hydrofluoric acid (HF) electrolytes in a standard electrochemical cell made out of Teflon.™ A Viton™ O-ring was used to seal the cell. The wafers were pressed against the gasket with an aluminum plate. Wire form platinum was immersed in the solution as the counter electrode. All etching was performed under constant current conditions, with proper current provided by an Agilent™ E3612A DC Power Supply. The unpolished side of the wafer was coated with aluminum to reduce the contact resistance to the aluminum back plate.

For all the results reported here, the etchings are performed using dimethylformamide (DMF) and a 49% HF solution at different volume ratios. The control of pores diameter, depth and spacing was achieved entirely through the variation of the etching conditions such as current density, etch time and wafer resistivity. Careful control of the various etching parameters is needed, as the pSi structure is very sensitive to processing conditions. After the reliability of the DMF etch was established, more than 40 samples were produced by using different etching conditions. Four sets of etching conditions are shown in Table (1).

TABLE 1
Etching parameters for pSi preparation

| Sample# | Figures | Current | Concentration of solution | Time(min) |
|---|---|---|---|---|
| A | 2a and | 3 mA | HF:DMF, 2 ml:25 ml | 210 |
| | 2b | | | |
| B | 2c and | 7 mA | HF:DMF, 1:10 | 210 |
| | 2d | | | |
| C | 2e and | 5 mA | HF:DMF, 1:10 | 250 |
| | 2f | | | |
| D | 2g and | 7 mA | HF:DMF, 1:10 | 200 |
| | 2h | | | |

After etching, the wafers were rinsed with methanol and water to take away the etching solution and by-products. The wafers were coated with a 20 nm gold coating, via E-Beam evaporation, to prevent surface oxidation.

A three-electrode electrochemical cell (Hosen Test™ cell, Hohsen™ Corp. Japan) was used for all electrochemical measurements. Porous silicon was used as a working electrode and lithium foil as counter electrode. The backside of the porous silicon was coated with aluminum or copper, but copper was preferred. Fiber glass was used as a separator, wetted with an electrolyte. The electrolyte was 1.0 M LiPF₆ in 1:1 w/w ethylene carbonate: diethyl carbonate (Ferro™ Corporation).

All the cells are made in an Argon-filled glove box. All the experiments were performed using Arbin Instruments™ BT2000. Various pSi samples were cycled between 0.09 and 1.5 V versus Li/Li+ and other voltage with different current density.

The porosity and thickness of the pSi layer were among the most important parameters which characterize pSi.²⁷ The porosity is defined as the fraction of void within the pSi layer and can be determined easily by weight measurements. The Siltronix™ and University™ wafers are first weight before anodisation (m¹), then just after anodisation (m²), and finally after dissolution of the whole porous layer in a molar NaOH aqueous solution (m³). The porosity is simply given by this equation:

$$P ( \% ) = \frac{{m}^{1} - {m}^{2}}{{m}^{1} - {m}^{3}} \qquad ( 1 )$$

From the measured mass it is also possible to measure the thickness of the layer according to the following formula:

$$\begin{matrix}W = \frac{{m}^{1} - {m}^{3}}{S \times d} & ( 2 ) \\ {m}^{1} - {m}^{3} = W \times S \times d & ( 3 )\end{matrix}$$

The thickness can also be directly determined by scanning electron microscopy (SEM). In Eq. (3), d is the density of bulk silicon and S is the wafer area exposed to HF during anodisation. Once thickness of porous, surface area and density of bulk silicon is known, the mass of porous area can be calculated by using Eq. (3).

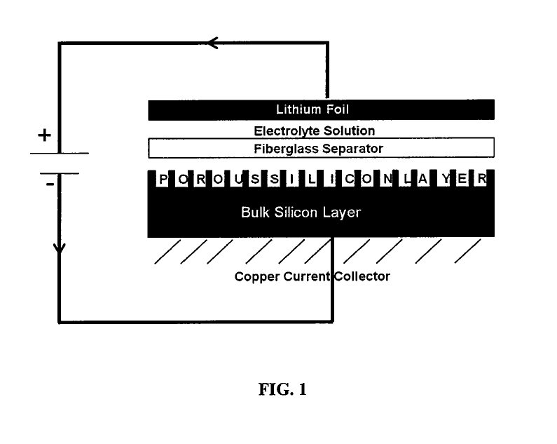

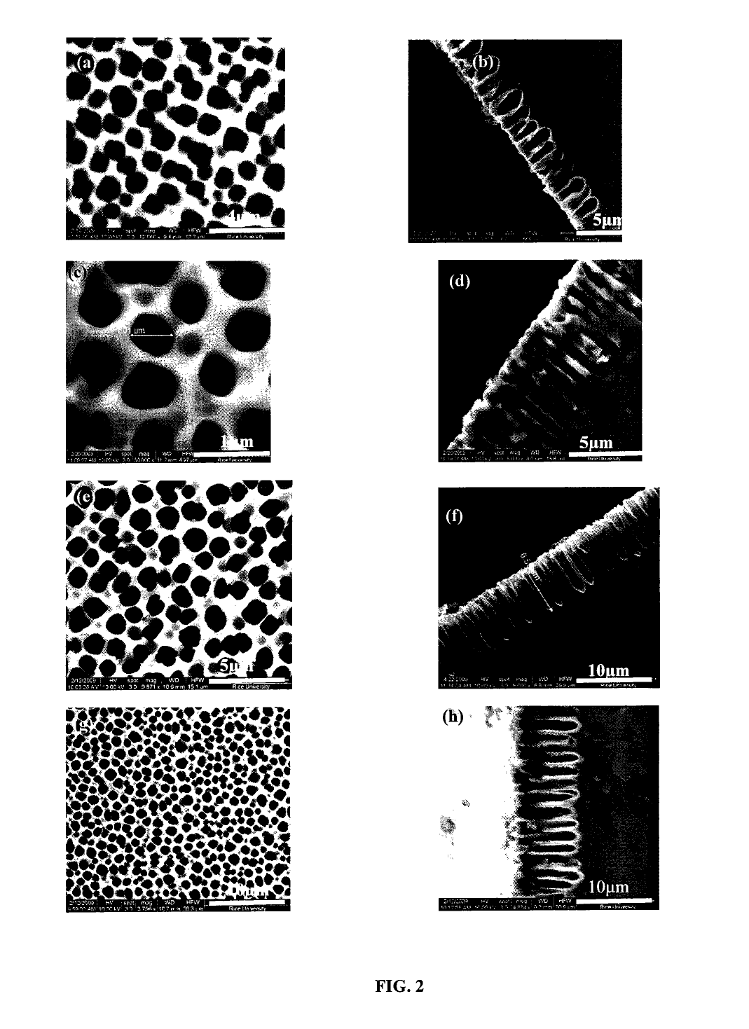

The porous silicon was studied for reversible charge performance by incorporating into the test cell as shown in FIG. 1. Shown in FIG. 2 are top and cross-sectional views of several pSi samples created by an electrochemical etching process under different conditions listed in Table 1. The physical structure of the pSi depended upon the etching condition. The pore depth increased with applied current and time. The porosity increased by decreasing the concentration of HF and/or increasing the current. The pores can vary from 10 nm to 10 μm in diameter with a pore depth of 2-100 μm, or preferably 5-15 μm, which are filled with electrolyte during the electrochemical testing.

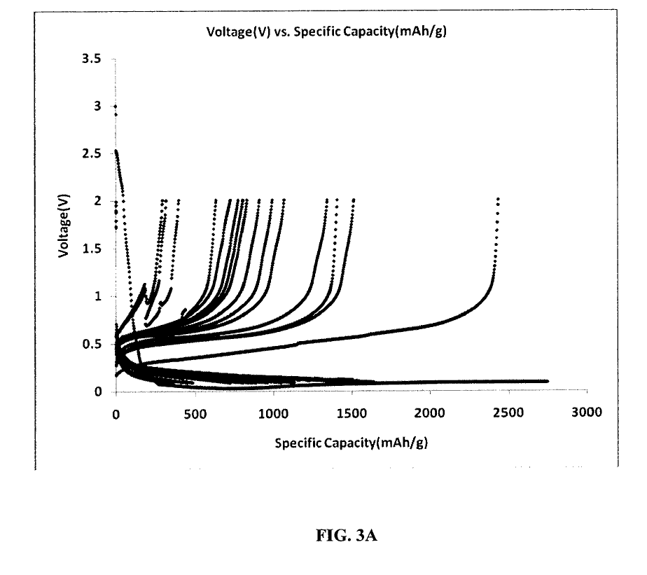

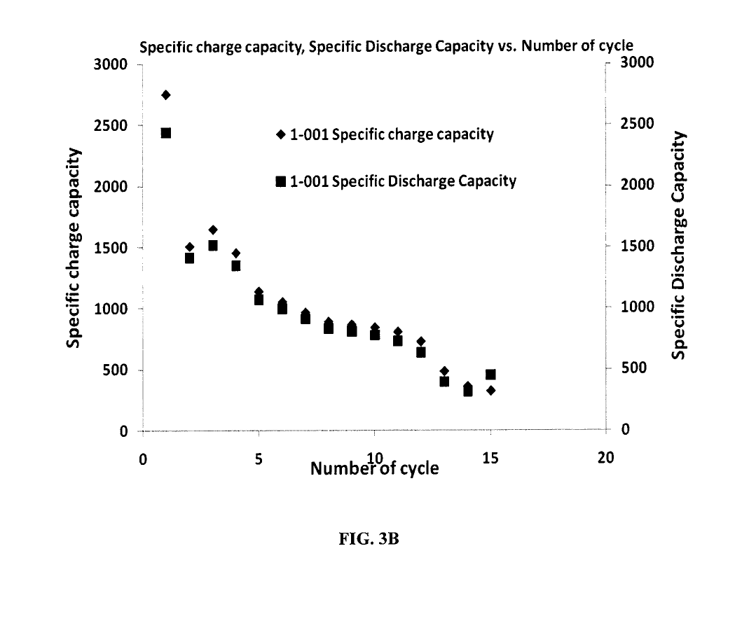

FIG. 3a shows the voltage profiles (between 0.09 to 2 V, at a charge rate of 60 μA) of the pSi electrode (sample A) pictured in top and side cross-sectional view in FIGS. 2a and b. The pore depth was 3.52 μm (aspect ratio=pore depth/diameter=3.52). Surface area of pSi electrode was 0.5 cm². The mass of the pSi calculated form Eq. 3 is 0.00041 g. The voltage profile observed was consistent with previous Si studies, with a long flat plateau during the first charge, during which crystalline Si reacted with Li to form amorphous LixSi.^{17,28-31} FIG. 3b shows the charge and discharge capacities for 15 cycles, as derived from FIG. 3a. The specific charge capacity for the 1st cycle was 2800 mAh/g, dropping down to 480 mAh/g at the 15th cycle, which is still greater than that of graphite.

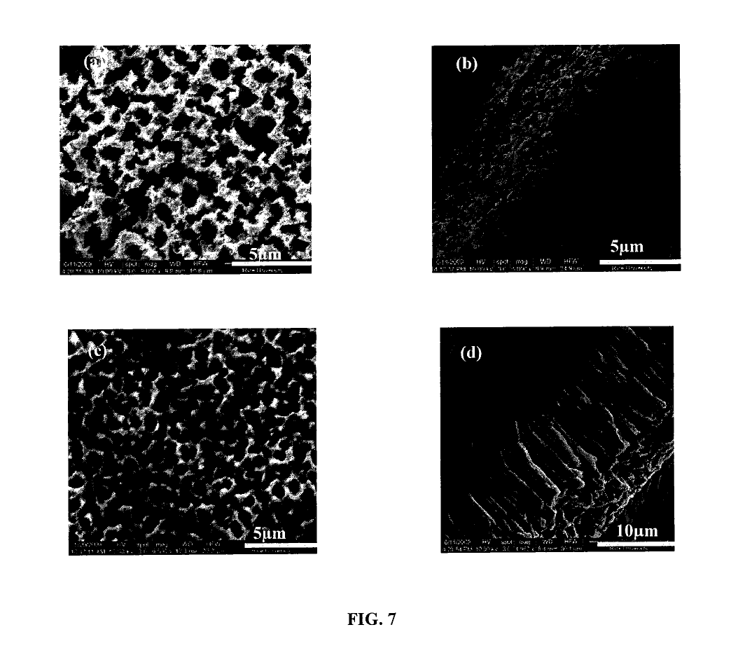

The structure morphology changes during Li insertion were studied to understand the high capacity and good cyclic stability of pSi electrode. FIG. 7a, b shows the top and cross-section view of the pSi after 15 cycles. After charging the pSi for 15 cycles, it was noted that the porous structure of the pSi electrode remained essentially the same after 15 cycles, in spite of the severe deformation of the channel wall. It is noted that, for this pSi material, aluminum was used as the current collector (not copper, as indicated in FIG. 1). The corrosion of aluminum by the electrolyte has been observed by others,¹¹ and severely affects the performance of batteries, degrading cycling ability and high rate performance. Therefore, the use of aluminum may have contributed to the irreversible capacity loss in first cycle.

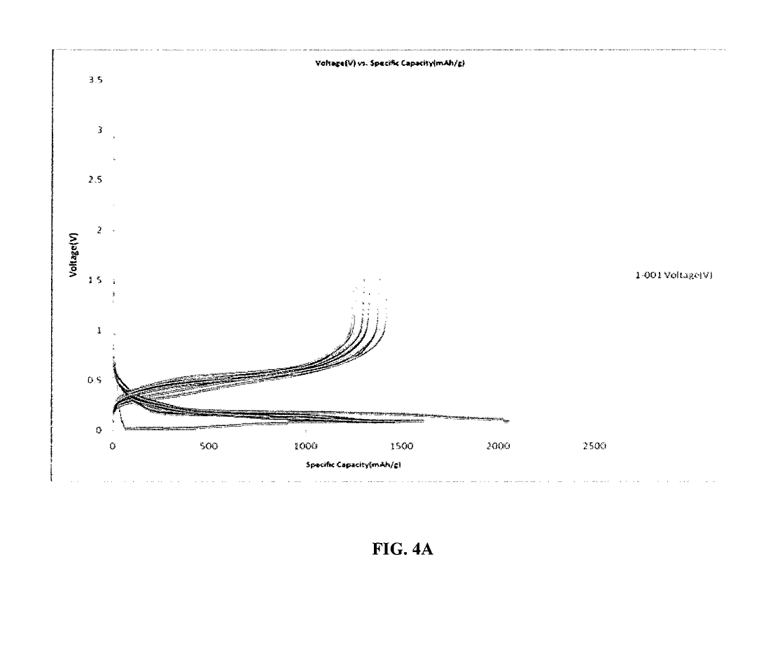

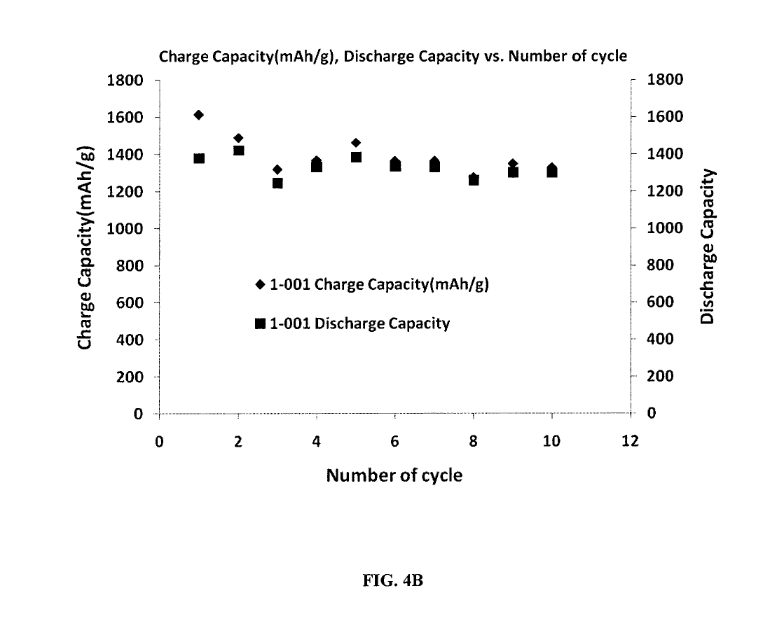

FIG. 4a show the voltage profiles of the pSi electrode (sample B) prepared at a higher current of 7 mA in a 5 cm² etch cell with lower amounts of HF and DMF such that the HF:DMF ratio was increased from 8:100 to 10:100 (FIGS. 2c and d). The pores were deeper, at 7.5 μm, and had diameters between 500 nm and 1.5 μm. The surface area and mass of pSi anode used in cell was 0.4 cm² and 0.000699 g. This cell was charged to 40% of theoretical capacity of Si, and the charge-discharge curves were observed at 60 μA between 0.09 to 1.5 V. It is seen that capacity through the 11^{th} cycle was ˜1400 mAh/g (FIG. 4b). After charging for 11 cycles, the pores were found to be intact (FIGS. 7c, d). For the testing of this anode, aluminum was also used as a current collecting material. After 11 cycles, the aluminum was totally decomposed by the electrolyte, resulting in cell failure.

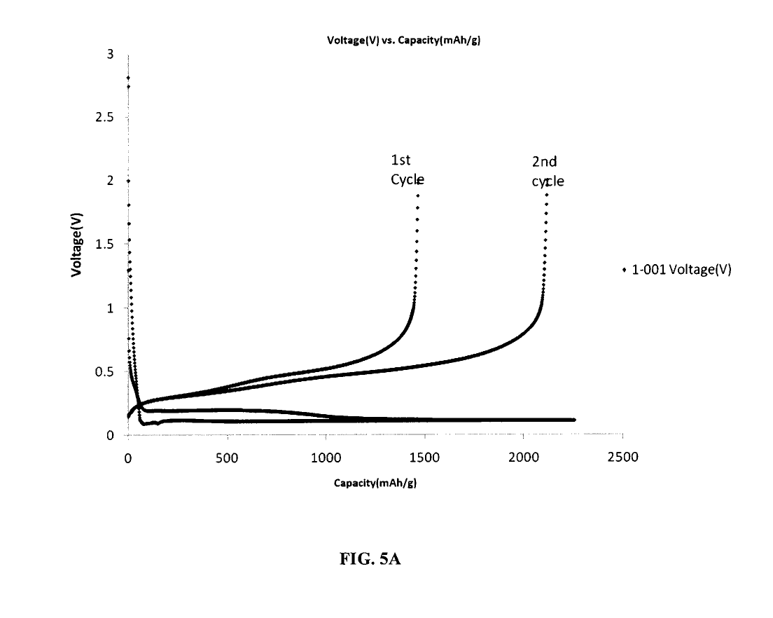

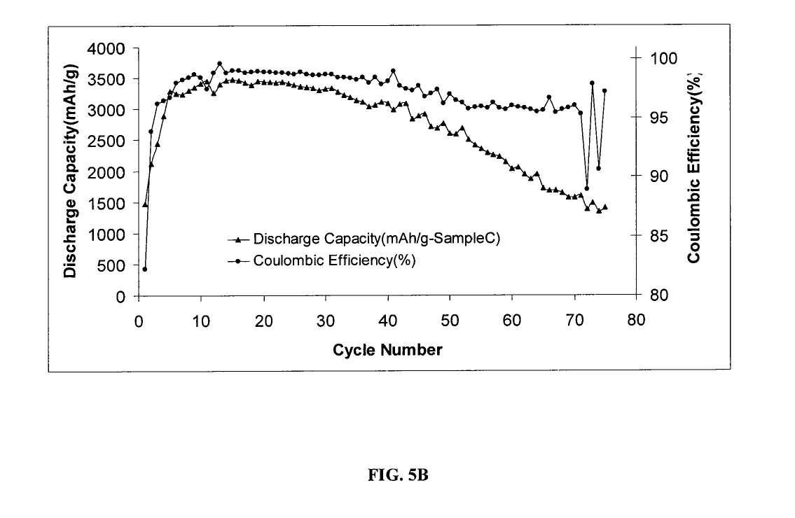

FIG. 5a show the voltage profiles of the pSi prepared like sample B, except at a lower current of 5 mA in a 5 cm² etch cell with longer etching time (FIGS. 2e and f). The pores of this sample C were slightly shallower at 6.59 μm. The surface area and mass of pSi anode was determined to be 0.64 cm² and 0.0009827 g. In this test cell, copper was used as the current collecting material. The charge-discharge curves were observed at 100 μA between 0.11 to 2 V. Dramatically different from the prior examples, the charge capacity increased with each cycle until the 5^{th} cycle, and reached a constant value of ˜3400 mAh/g, which is 80% of the theoretical capacity (FIG. 5b). Thus, this examples proves that a long lasting battery is possible with coated porous silicon.

This improvement in capacity and cyclic stability may reflect a unique feature of the pSi nanostructure that is observable only after changing to the stable copper current collecting material. We speculate that the unusual capacity increase results from an increasing amount of amorphous LiₓSi formed per cycle, suggesting the Li is accessing some part of the pSi structure in increasing amounts until 80% of the pSi is participating in reversible Li storage. This high capacity is maintained with high Coulombic efficiency of 95-99% to at least 76 cycles, as shown in FIG. 5b.

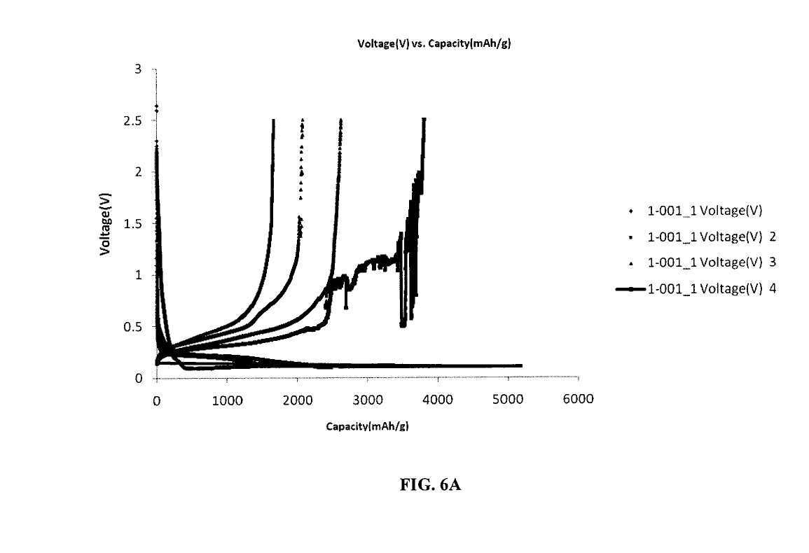

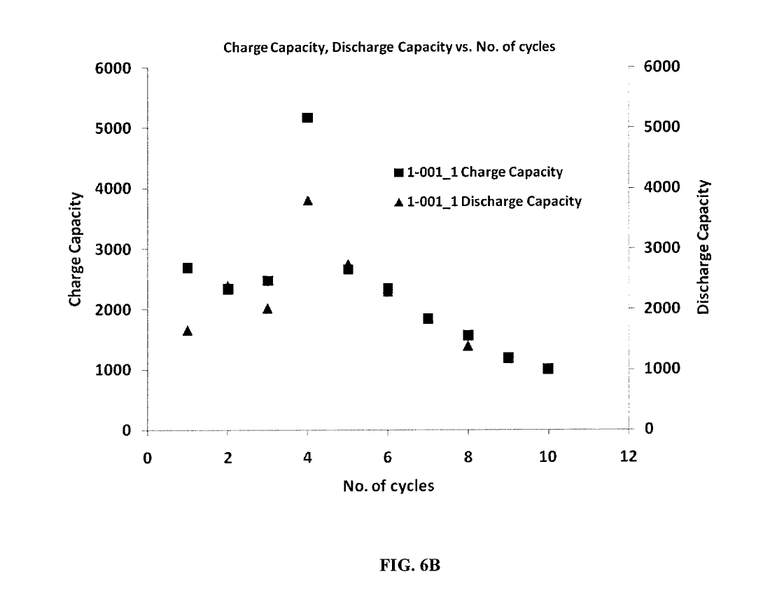

FIG. 6a shows the voltage profiles of the pSi prepared like sample B, except with a slightly shorter etch time of 200 seconds (FIGS. 2g and h). The pores were similarly deep (7.4 μm) compared to those of sample B. The surface area and mass of pSi electrode was 0.4 cm² and 0.00068968 g. The charge-discharge curves (at 40 μA between 0.11 and 2.5 V) showed that this pSi form overcharged in the 4th cycle, after which the charge capacity decreased with additional cycling (FIG. 6b). This degradation resulted from the overcharging of cell.

### EXAMPLE 2

The porosity, thickness, pore diameter and microstructure of porous silicon (pSi) depends on the anodization conditions. For a fixed current density, the porosity decreases as HF concentration increases. Additionally, the average depth increases and porosity decreases with increasing HF concentration (Table 2). Fixing the HF concentration and current density, the porosity increases with the thickness (Table 3). Increasing current density increases the pore depth and porosity (Table 4). This happens because of the extra chemical dissolution of the porous silicon layer in HF. The thickness of a porous silicon layer is determined by the time that the current density is applied, that is, the anodization times. Another advantage of the formation process of porous silicon is that once a porous layer has been formed, no more electrochemical etching occurs for it during the following current density variations.²⁷

TABLE 2
Effect of etch time on pSi structure.

| | Concentration | | | Porosity |
|---|---|---|---|---|
| Current | of solution | Time(min) | Average Depth | (%) |
| 9 mA | HF:DMF, 1:30 ml | 180 | 7.49 | 48 ± 3% |
| 9 mA | HF:DMF, 2:30 ml | 180 | 16.88 | 23 ± 3% |
| 9 mA | HF:DMF, 3:30 ml | 180 | 24.21 | 17 ± 3% |

TABLE 3
Effect of etch time on pSi structure.

| | Concentration | | | Porosity |
|---|---|---|---|---|
| Current | of solution | Time(min) | Average Depth | (%) |
| 9 mA | HF:DMF, 0.7:30 ml | 167 | 8.92 | 35 ± 3% |
| 9 mA | HF:DMF, 0.7:30 ml | 180 | 9.6 | 41 ± 3% |

TABLE 4
Effect of etch current on pSi structure.

| | Concentration | | | Porosity |
|---|---|---|---|---|
| Current | of solution | Time(min) | Average Depth | (%) |
| 5 mA | HF:DMF, 0.7:30 ml | 180 | 6.4 | 35 ± 3% |
| 7 mA | HF:DMF, 0.7:30 ml | 180 | 9.03 | 38 ± 3% |
| 9 mA | HF:DMF, 0.7:30 ml | 180 | 9.6 | 41 ± 3% |

### EXAMPLE 3

The cycle life and specific capacity of pSi structures with different porosities but the same average pore depth were compared. Etching parameters for creating same depth and different porosity of porous silicon (pSi) are given in (Table 5). Shown in the FIG. 8 are top and cross-sectional views of pSi samples, with the same depth and differing porosity.

TABLE 5
Etching parameter for creating same average depth and different porosity.

| | | | | Time | Average | Porosity |
|---|---|---|---|---|---|---|
| Sample | FIGS. | Current | Concentration | (min) | Depth | (%) |
| E | 8a 8b | 8 mA | HF:DMF, | 180 | 5.6 | 60 ± 2% |
| | | | 1:35 ml | | | |
| F | 8c 8d | 5 mA | HF:DMF, | 180 | 5.49 | 36 ± 2% |
| | | | 0.7:30 ml | | | |

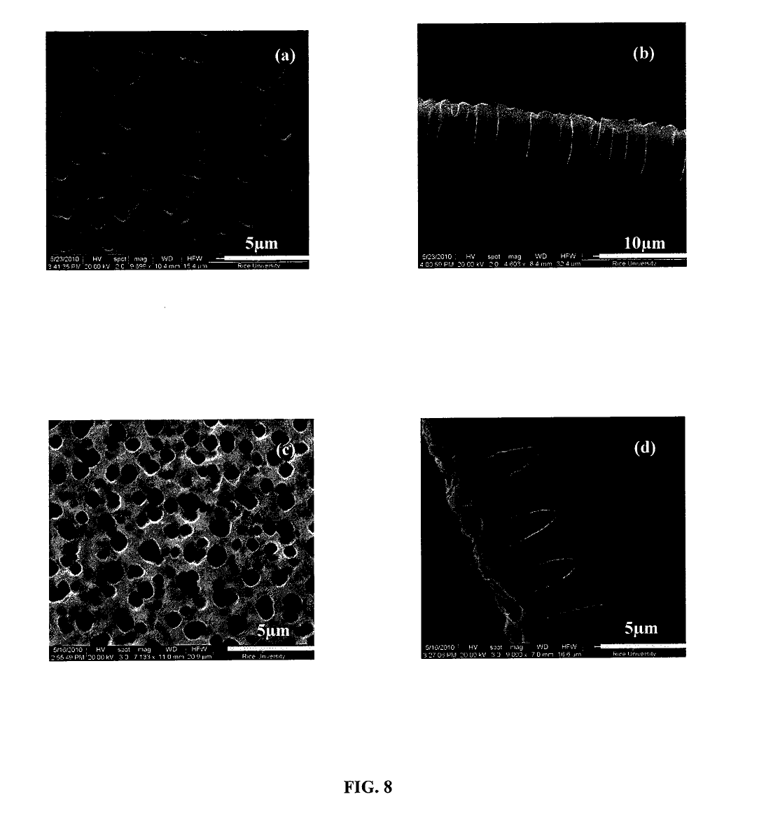

FIG. 9 shows the specific capacities versus cycles for sample E and sample F of different porosity and same average depth. The cell is charge and discharged between 0.09 to 1.5 V, at a rate of 200 μA. The average pore depth of sample is 5.6 and 5.49 μm. The mass of the pSi calculated form Eq. 3 was 0.00098 g. It is seen that specific capacity as well as cycle life for the sample F were better as compared to sample E.

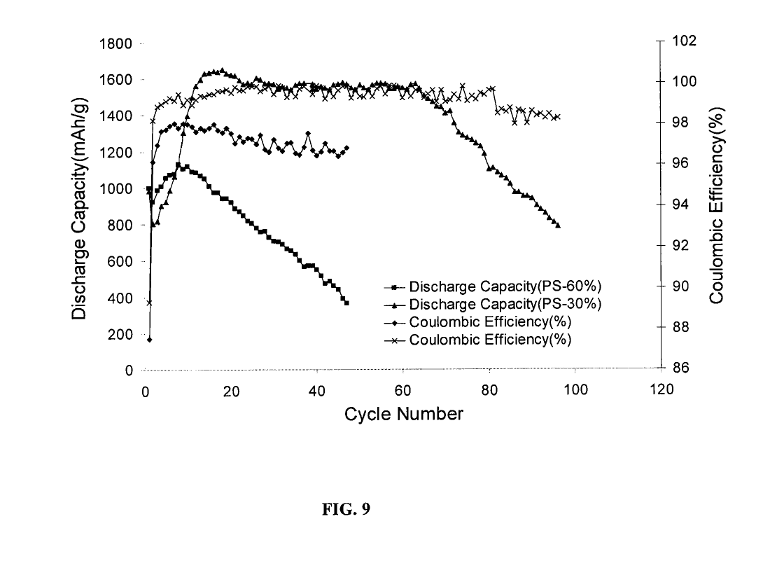

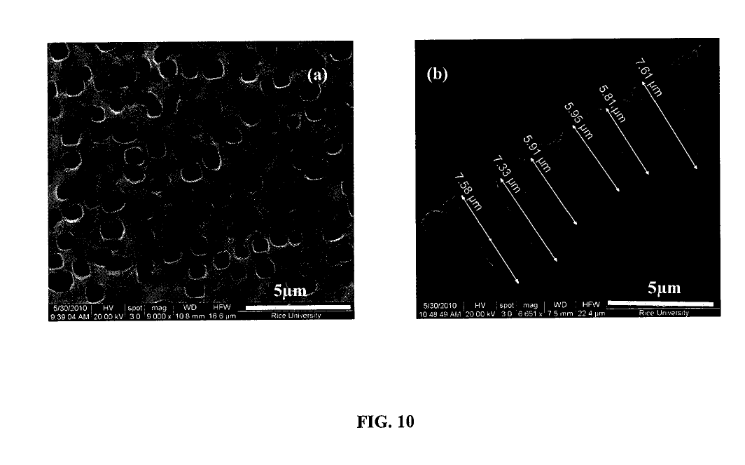

The cycle life and specific capacity of pSi structures with almost same porosities but different average pore depth were compared. Etching parameters for creating same porosity and different depth of porous silicon (pSi) are given in (Table 6). Shown in FIG. 10 are top and cross-sectional views of pSi samples, with same porosity and different depth.

TABLE 6
Etching parameter for creating same porosity and different depth.

| | | | | Time | Average | Porosity |
|---|---|---|---|---|---|---|
| Sample | FIGS. | Current | Concentration | (min) | Depth | (%) |
| E | 8a 8b | 8 mA | HF:DMF, | 180 | 5.6 | 60 ± 2% |
| | | | 1:35 ml | | | |
| G | 10a 10b | 9 mA | HF:DMF, | 180 | 7.07 | 52 ± 2% |
| | | | 1:30 ml | | | |

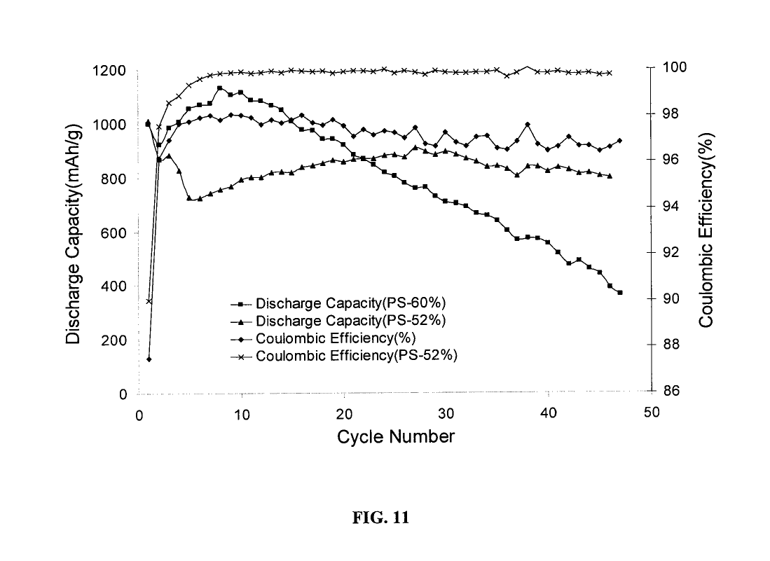

FIG. 11 shows the specific capacities versus cycles for sample E and sample G of different depth and almost same porosity. The cell was charged and discharged between 0.09 to 1.5 V, at a rate of 200 μA. The average pore depth of sample was 5.6 and 7.07 μm. Specific capacity as well as cycle life for deeper pores (sample G) was better as compared to the sample E. The pSi sample having more average depth can hold more lithium ion which leads to better cycle life as well as capacity.

### EXAMPLE 4

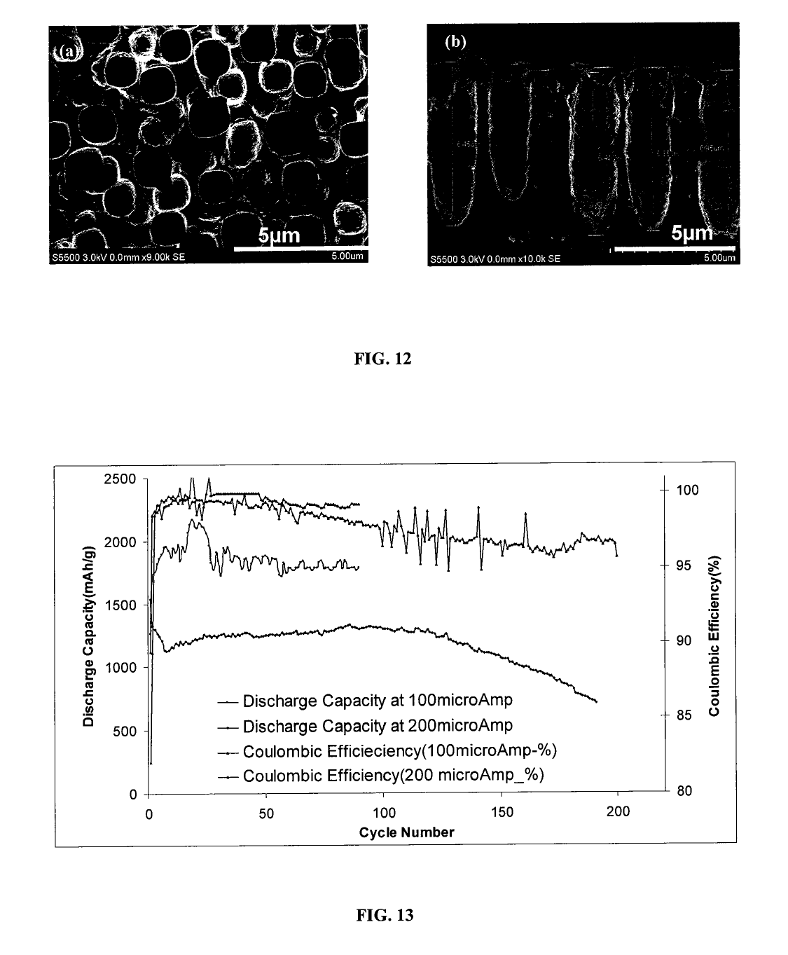

The cycle life and specific capacity of wider pSi structures etched at different conditions was tested. Etching parameters for creating wider pores are given in (Table 7). Shown in FIG. 12a and b are top and cross-sectional views of pSi samples with wider pores.

TABLE 7
Etching parameter for creating wider pores.

| | | | | | Average |
|---|---|---|---|---|---|
| Sample | Figures | Current | Concentration | Time (min) | Depth |
| H | 12a 12b | 8 mA | HF:DMF:Water, | 240 | 6.59 |
| | | | 1:10:1 | | |

FIG. 13 shows the specific capacities versus cycles for sample H. The pSi is etched at different conditions as compared to the other samples. The sample is etched at 8 mA in a 5 cm² etch cell. The pores of this sample are wider (average 2 microns). The mass of pSi anode was determined to be 0.00098 g. The charge-discharge curves were observed at 100 μA and 200 μA between 0.095 to 1.5 V for the same sample. This sample gives better cycle life and less capacity, but 4 times more as compared to graphite. The cell is able to charge and discharge till cycle 230 at the higher rate of 200 μA. Thus, for maximum cyclability, pore width should be increased.

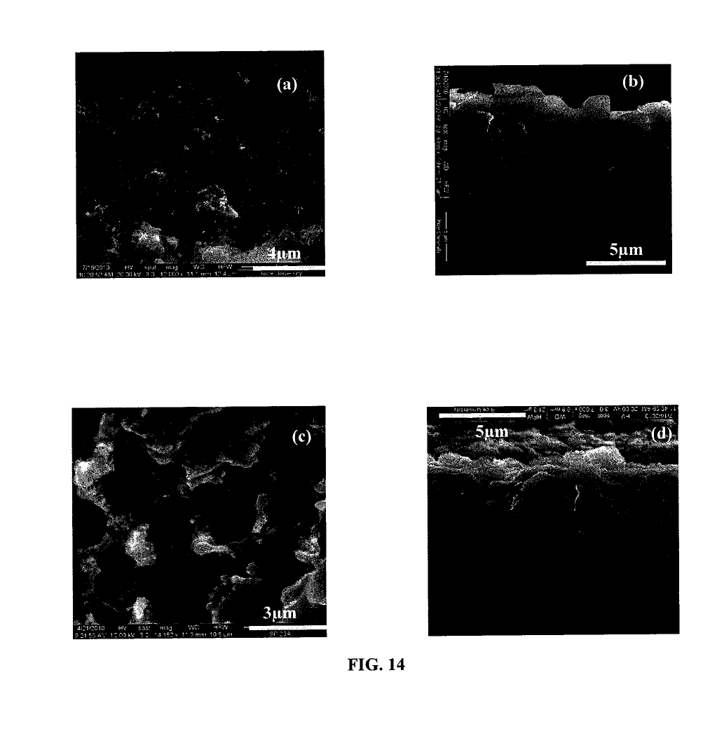

Morphology changes during Li insertion were studied to understand the high capacity and good cyclic stability of the pSi electrode. FIG. 14a, b shows the top and cross-section view of the pSi after 230 cycles of charge and discharge at 200 μA. FIG. 14c, d shows the top and cross-section view of the pSi after 90 cycles of charge and discharge at 100 μA. It is noted that if the cell is charged and discharged at higher rate it take longer time to change the structure morphology as compared to the slow charging and discharging.

### EXAMPLE 5

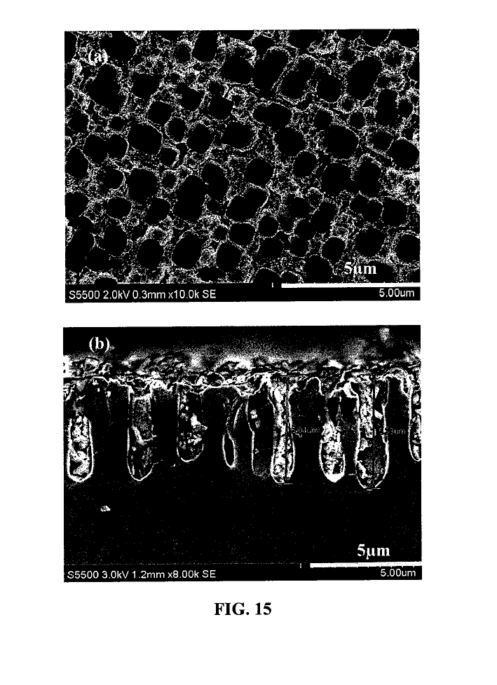

The cycle life and specific capacity of pSi structures etched after coating with Si nano-particles was tested. A 1M solution of Si particles in ethanol was spotted onto the silicon wafer before etching, dried overnight and etching was performed using the parameters of Table 8. Shown in FIGS. 15a and b are top and cross-sectional views of these pSi samples.

TABLE 8
Etching parameter for creating wider pores.

| | | | | | Average |
|---|---|---|---|---|---|
| Sample | Figure | Current | Concentration | Time(min) | Depth |
| I | 15a 15b | 8 mA | HF:DMF, 2:25 ml | In intervals of | 5.3 |
| | | | | 30 minutes for | |
| | | | | 120 minutes | |

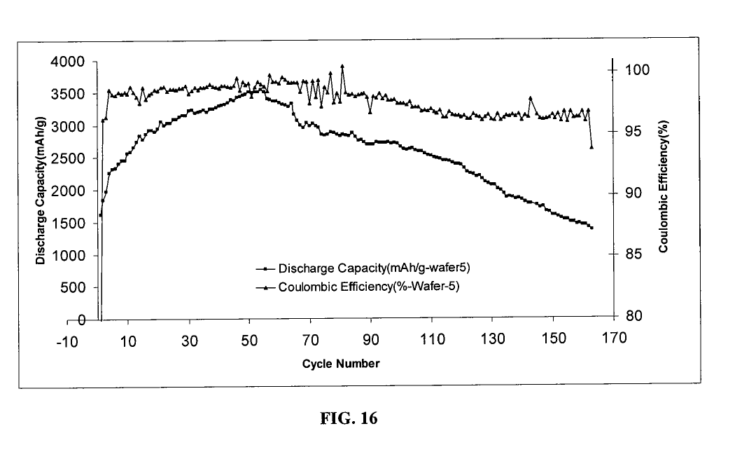

FIG. 16 shows the specific capacities versus cycles for sample I. The Si was etched after coating with SiNP at 8 mA in a 5 cm² etch cell. The mass of pSi anode was determined to be 0.0007725 g. The charge-discharge curves were observed at 100 μA till cycle 55, for the 55^{th}-65^{th} cycle the cell was charged and discharged at 150 μA and after the 65^{th} cycle it was charged and discharged at 200 μA between 0.11 to 2V for the same sample. This sample gives higher capacity for large number of cycles, and was able to charge and discharge till cycle 170. Thus, reducing porosity gave the best capacity.

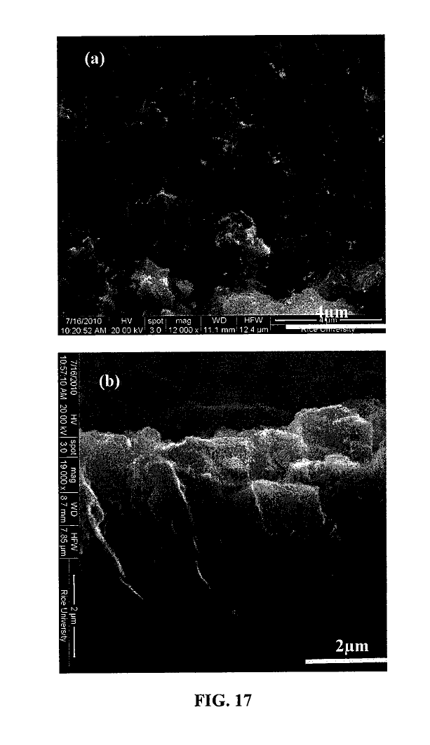

The structure morphology changes during Li insertion were studied to understand the high capacity and good cyclic stability of pSi electrode. FIG. 17a, b shows the top and cross-section view of the pSi after 170 cycles charge.

### EXAMPLE 6

The cycle life and specific capacity of deeper pSi structures was also tested. Etching parameters for fabricating deeper pores are given in Table 9. Shown in the FIG. 19a and b are top and cross-sectional views of pSi samples.

TABLE 9
Etching parameter for creating wider pores.

| | | | | | Average |
|---|---|---|---|---|---|
| Sample | Figure | Current | Concentration | Time (min) | Depth |
| J | 19a 19b | 9 mA | HF:DMF:Water | 360 min | 21 μm |
| | | | 2:30:2 ml | | |

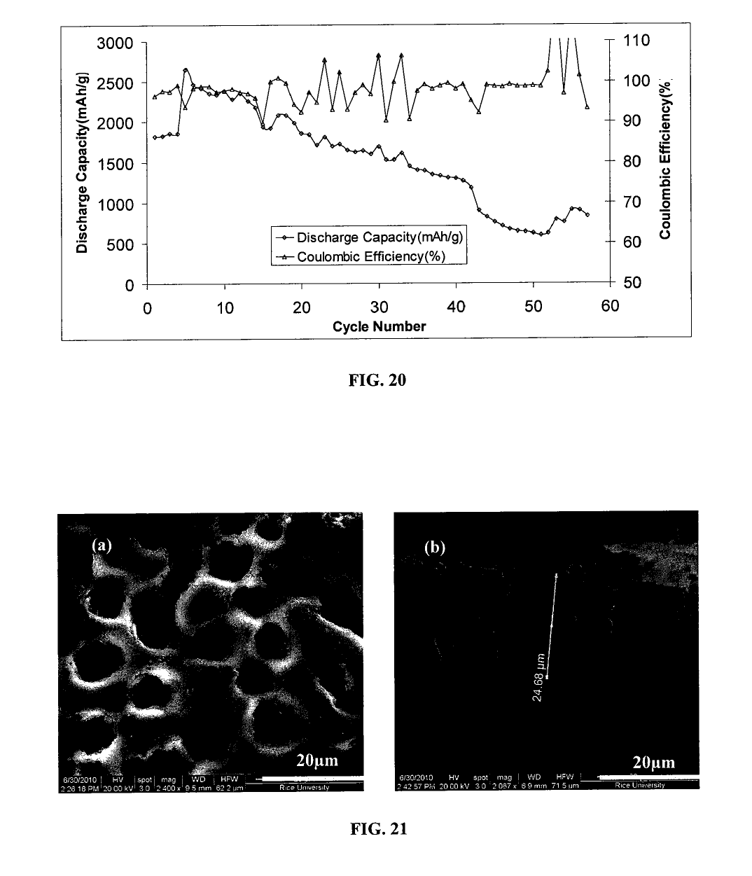

FIG. 20 shows the specific capacities versus cycles for sample J. This sample has deeper pores as compared to the prior samples. The sample is etched at 9 mA in a 5 cm² etch cell. The mass of pSi anode was determined to be 0.0034 g. The charge-discharge curves were observed at 300 μA till cycle 43 and then the cell was charged and discharged at 500 μA and after the 65^{th} cycle it was charged and discharged at 200 μA between 0.09 to 1.5 V. This sample gave an average capacity of 1600 mAh/g, and the cell was able to charge and discharge till 58 cycles.

The structure morphology changes during Li insertion were studied to understand the high capacity and good cyclic stability of pSi electrode. FIG. 21a, b shows the top and cross-section view of the pSi after 58 cycles.

A complete summary of the copper backed samples is presented in table 10:

TABLE 10
Summery of etching parameter of samples with
copper as current collecting materials

| Sam- | Pore | Pore | | Max./min. | Cycle |
|---|---|---|---|---|---|
| ple | width | depth | Current | Capacity | Life |
| C | ≦1 μm | 6.59 μm | 100 μA | 3500/1500 | 76 cycles |
| E | ≦1 μm | 5.6 μm | 200 μA | 1300/600 | 50 cycles |
| F | ≦1 μm | 5.49 μm | 200 μA | 1600/800 | 100 cycles |
| G | ≦1 μm | 7.07 μm | 200 μA | 1000/800 | 100 cycles |
| H | 2 μm | 6.59 μm | 100 μA | 1300/600 mAh/g | 230 cycles |
| | | | 200 μA | 2300/1800 mAh/g | 90 cycles |
| I | ≦1 μm, | 5.3 μm | 100, 150 | 3500/1500 mAh/g | 170 cycles |
| | Coated | | and 200 μA | | |
| | with SiNP | | | | |
| J | ≦1 μm | 21 μm | 300/500 μA | 1600/800 mAh/g | 50 cycles |

### EXAMPLE 7

Although we have exemplified the processes herein with the use of a macroscopically flat wafer, the porous silicon need not be flat, and can be applied to other Si structures, for example, pillars, thick or thin free-standing wires, and three-dimensionally porous Si, and supported on bulk Si or other substrates as needed for structural stability. Thus, the porous silicon need not be flat in macro- or microscopic dimension, but can have a variety of topologies. A commonality of these structures is they have higher surface area-to-volume ratios than that of bulk Si, and some of these Si structures have been shown to be effective battery anodes. A mixture of Si structures supported on bulk Si may be effective battery anodes also. Thus, existing pillars and wires can be further improved with the etching and coating technique as described herein. Alternatively, pillars can be produced by carrying on the etching until such point as pillars are formed by removal of sufficient silicon.

### EXAMPLE 8

Bulk Si can provide structural support for the pSi and can further improve cycle life, with an optional transitional layer between the porous and bulk silicon being important in some applications. This transitional layer experiences decreasing lithiation based on distance from the bottom of the pores. The bulk silicon just beneath the porous silicon provides a good electrical conductivity path in the structure to the current collector, which can be doped to make it even more electrically conductive. This electrical conductivity can improve cell performance by reducing internal cell electrical resistance and consequent voltage losses. The transitional layer, which experiences decreasing lithiation as a function of depth, also functions as a stress gradient, enabling the cyclically lithiated and delithiated inter-pore silicon to stay physically attached to the bulk silicon substrate.

### EXAMPLE 9

The electrochemical etch process can be applied to other substrates besides the prime grade, boron doped, p-type and single-side polished silicon wafers from Siltronix™ and University™ wafers used in Example 1. A silicon layer that has been deposited on another material, which can act as a current collector or a manufacturing structure, can be used as a substrate. This will enable further efficiencies in manufacturer of battery anodes with the pSi etched in place on a convenient substrate suitable to manufacturing processes. The substrate may be removable or it may be retained in the final anode structure. The substrate can have other functions, such as a structural part of the cell and/or as a current collector. This can be formed as a discrete substrate or in a continuous format, facilitating roll-to-roll manufacturing processes suitable for battery manufacture. An example would be deposition of silicon, in various possible forms (crystalline, polycrystalline, amorphous, silicon carbine, etc.) on a roll-to-roll copper substrate. This silicon would then be made porous. The copper/porous silicon structure could then be mated with other components of a secondary lithium battery cell in a continuous form.

### EXAMPLE 10

The pSi structure can be also combined with a carbon material to improve cycle life. Possible carbon supports include, carbon fibers, graphene sheets, fullerenes, carbon nanotubes, and graphene platelets. Alternatively, any of these forms of carbon can contribute to the passivation coating.

### EXAMPLE 11

The electrochemical etch process can proceed in other geometries besides a closed etch cell, for example, in a open system with the Si substrate immersed in containing the etch fluid. Thus, the invention is not limited to the way that the etch is performed.

### EXAMPLE 12

Plasma etching, which does not involve the use of corrosive HF, can also generate pSi structures. There are examples of creating pSi structures using a variety of plasma gases, such as SF₆, CF₄, BCl₃, NF₃, and XeF₂.

### EXAMPLE 13

Porous silicon wafers can be subjected to a size reduction process such as roll or hammer crushing and ball-milling or attriting. The resultant powder-like material can then be used to manufacture Li-ion batteries by the processes typically used for making Li-ion batteries such as the known mixing, coating and calendaring processes. Thus, the coated porous silicon can be used as is, or ground and mixed with a matrix or other binding agent and formed into the desired anode shape.

### EXAMPLE 14

A self-standing porous silicon layer is produced by modifying the electrochemical process. For a given silicon doping level and type, current density and HF concentration are the two main anodizing parameters determine the microstructure and porosity of layers. Keeping this in mind, a porous silicon layer can be separated from the substrate in a one step separation (OSS) or a two step separation (TSS) method.

The one step anodization lift-off procedure is driven by the dissolution of fluorine ions as the pores grow deeper. The dissolution of fluorine ions create high porosity layer (50-80% porous) below a less porous layer (10-30% porous). The pores then expand to overlap one another until the porous silicon breaks away from its substrate.

In order to perform the TSS, a silicon wafer is etched at a constant current density to create long; straight pores, and then a dramatic boost in the current density expands the pores rapidly to create an electro-polished layer that then allows the porous silicon to disconnect from the wafer.

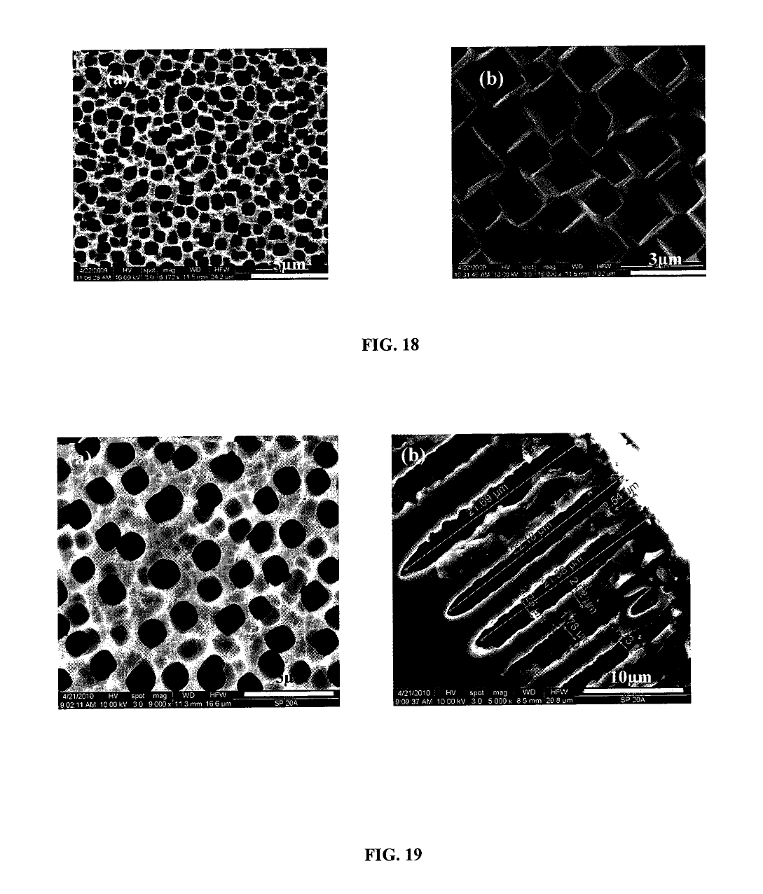

The two step etch process was carried out successfully in organic solutions. The initial low porous layer was etched at room temperature with a current ranging from 5-12 mA for any where between 1-3 hours. This initial etching condition creates the main parts of the porous layer. Boosting the current density between 40-300 mA after the initial etching caused the base of the pores to expand and overlap and allowed the porous layer to separate from the substrate. This electropolishing lift-off step is carried out for 10 minutes to 1 hour. All of these parameters can be tuned to create porous structures of different sizes. A layer of lift-off self-standing porous silicon layer is directly put on the current collecting materials. FIG. 18 shows the front and back side of an exemplary lift-off using the TSS.

The following references are incorporated by reference herein in their entirety:
1. Kanno, R., Takeda, Y., Ichikawa, T., Nakanishi, K. & Yamamoto, O., Carbon As Negative Electrodes In Lithium Secondary Cells. Journal of Power Sources 26, 535-543 (1989).
2. Mohri, M., et al. Rechargeable Lithium Battery Based On Pyrolytic Carbon As A

Negative Electrode. Journal of Power Sources 26, 545-551 (1989).
3. Besenhard, J. O., Yang, J. & Winter, M. Will advanced lithium-alloy anodes have a chance in lithium-ion batteries? Journal of Power Sources 68, 87-90 (1997).
4. Yoshio, M., Kugino, S. & Dimov, N. Electrochemical behaviors of silicon based anode material. Journal of Power Sources 153, 375-379 (2006).
5. Kim, I., Kumta, P. N. & Blomgren, G. E. Si/TiN nanocomposites—Novel anode materials for Li-ion batteries. Electrochemical and Solid State Letters 3, 493-496 (2000).
6. Bourderau, S., Brousse, T. & Schleich, D. M. Amorphous silicon as a possible anode material for Li-ion batteries. Journal of Power Sources 81, 233-236 (1999).
7. Li, H., et al. The crystal structural evolution of nano-Si anode caused by lithium insertion and extraction at room temperature. Solid State Ionics 135, 181-191 (2000).
8. Weydanz, W. J., Wohlfahrt-Mehrens, M. & Huggins, R. A. A room temperature study of the binary lithium-silicon and the ternary lithium-chromium-silicon system for use in rechargeable lithium batteries. Journal of Power Sources 81, 237-242 (1999).
9. Li, H., Huang, X. J., Chen, L. Q., Wu, Z. G. & Liang, Y. A high capacity nano-Si composite anode material for lithium rechargeable batteries. Electrochemical and Solid State Letters 2, 547-549 (1999).
10. Ng, S. B., Lee, J. Y. & Liu, Z. L. Si—O network encapsulated graphite-silicon mixtures as negative electrodes for lithium-ion batteries. Journal of Power Sources 94, 63-67 (2001).
11. Kasavajjula, U., Wang, C. S. & Appleby, A. J. Nano- and bulk-silicon-based insertion anodes for lithium-ion secondary cells. Journal of Power Sources 163, 1003-1039 (2007).
12. Ryu, J. H., Kim, J. W., Sung, Y. E. & Oh, S. M. Failure modes of silicon powder negative electrode in lithium secondary batteries. Electrochemical and Solid State Letters 7, A306-A309 (2004).
13. Kim, J. W., Ryu, J. H., Lee, K. T. & Oh, S. M. Improvement of silicon powder negative electrodes by copper electroless deposition for lithium secondary batteries. Journal of Power Sources 147, 227-233 (2005).
14. Li, J., Christensen, L., Obrovac, M. N., Hewitt, K. C. & Dahn, J. R. Effect of heat treatment on Si electrodes using polyvinylidene fluoride binder. Journal of the Electrochemical Society 155, A234-A238 (2008).
15. Yoshio, M., et al. Carbon-coated Si as a lithium-ion battery anode material. Journal of the Electrochemical Society 149, A1598-A1603 (2002).
16. Morita, T. & Takami, N. Nano Si cluster-SiOx-C composite material as high-capacity anode material for rechargeable lithium batteries. Journal of the Electrochemical Society 153, A425-A430 (2006).
17. Ou Jung Kwon, Y. J. L., Won Seok Chang, Ki-Tae Kim, Seo-Jae Lee and Ki-Young Lee. Si-Graphite Composite as a New Anode Material for Lithium Secondary Batteries. ECS Transactions 1, 5 (2005).
18. Chan, C. K., et al. High-performance lithium battery anodes using silicon nanowires. Nature Nanotechnology 3, 31-35 (2008).
19. Chan, C. K., Zhang, X. F. & Cui, Y. High capacity Li ion battery anodes using Ge nanowires. Nano Letters 8, 307-309 (2008).
20. Cui, L. F., Ruffo, R., Chan, C. K., Peng, H. L. & Cui, Y. Crystalline-Amorphous Core-Shell Silicon Nanowires for High Capacity and High Current Battery Electrodes. Nano Letters 9, 491-495 (2009).
21. Li-Feng Cui, Y. Y., Ching-Mei Hsu, and Yi Cui, Carbon-Silicon Core-Shell

Nanowires as High Capacity Electrode for Lithium Ion Batteries. Nano Letters (2009).
22. Graetz, J., Alm, C. C., Yazami, R. & Fultz, B., Highly reversible lithium storage in nanostructured silicon. Electrochemical and Solid State Letters 6, A194-A197 (2003).
23. Gao, B., Sinha, S., Fleming, L. & Zhou, O. Alloy formation in nanostructured silicon. Advanced Materials 13, 4 (2001).
24. Shin, H. C., Corno, J. A., Gole, J. L. & Liu, M. L. Porous silicon negative electrodes for rechargeable lithium batteries. Journal of Power Sources 139, 314-320 (2005).
25. Kang, D. K., Corno, J. A., Gole, J. L. & Shin, H. C. Microstructured nanopore-walled porous silicon as an anode material for rechargeable lithium batteries. Journal of the Electrochemical Society 155, A276-A281 (2008).
26. Netz, A., Huggins, R. A. & Weppner, W. The formation and properties of amorphous silicon as negative electrode reactant in lithium systems. Journal of Power Sources 119, 95-100 (2003).
27. Li, J. & Dahn, J. R. An in situ X-ray diffraction study of the reaction of Li with crystalline Si. Journal of the Electrochemical Society 154, A156-A161 (2007).
28. Obrovac, M. N. & Krause, L. J. Reversible cycling of crystalline silicon powder. Journal of the Electrochemical Society 154, A103-A108 (2007).
29. Hatchard, T. D. & Dahn, J. R. In situ XRD and electrochemical study of the reaction of lithium with amorphous silicon. Journal of the Electrochemical Society 151, A838-A842 (2004).
30. Halimaoui, A. Porous silicon formation by anodisation. in Properties of Porous Silicon (ed. Canhan, L.) 18 (The Institution of Electrical Engineering, Lodon, August 1997).

What is claimed is:

1. A method of making coated porous silicon, comprising:
(a) etching silicon in an electrochemical cell under current to produce porous silicon having pores from 10 nm to 10 μm in diameter with an pore depth of 5-100 μm, and
(b) coating said porous silicon with at least 1 nm of a passivating material, wherein said coated porous silicon has a charge capacity of at least 1000 mAh/g for at least 50 cycles.

2. The method of claim 1, wherein said etching uses a high density plasma gas or an acid.

3. The method of claim 1, wherein said silicon is crystalline silicon, semicrystalline silicon, amorphous silicon, doped silicon, coated silicon, silicon precoated with silicon nanoparticles, or combinations thereof.

4. The method of claim 1, wherein said acid comprises hydrofluoric acid (HF) in dimethylformamide (DMF).

5. The method of claim 1, wherein said coating is carbon or gold.

6. The method of claim 1, wherein said coating is about 20 nm of gold.

7. The method of claim 2, wherein the porosity can be increased by decreasing the concentration of acid and/or increasing the current.

8. The method of claim 1, wherein the coated porous silicon has a pore depth of 5-10 μm and a charge capacity of at least 2000 mAh/g for at least 60 cycles.

9. The method of claim 1, wherein the coated porous silicon has a pore width of about 2 μm and a lifespan of at least at least 200 cycles.

10. The method of claim 1, wherein the silicon is pretreated with silicon nanoparticles, and the coated porous silicon has an pore width of about less than 1 μm, a depth of 5-10 μm and a lifespan of at least at least 150 cycles.

11. The method of claim 3, wherein the current ranges from 1-20 mA, the HF:DMF ratio ranges from 1:5 to 1:35 and the current is applied for 30-300 minutes.

12. The method of claim 3, wherein the current is 8 mA, the HF:DMF:water ratio is 1:10:1, the current is applied for 240 minutes, and the pore depth is at least 6 microns and pore diameter is at least 2 microns.

13. The method of claim 3, wherein the current is 8 mA, the HF: DMF ratio is 2:25, and the current is applied in intervals of about 30 minutes for about 120 minutes, and the pore depth is at least 5 microns.

14. The method of claim 1, comprising:
(a) etching crystalline silicon in HF:DMF in a ratio of 1:5-1:35 in an electrochemical cell at 3-10 mA, under constant or intermittent current for 30-300 minutes, to produce porous silicon having pores from 10 nm to 10 μm in diameter with a pore depth of 5-250 μm,
(b) coating said porous silicon with 5-50 nm gold, wherein said coated porous silicon has a charge capacity of at least 3000 mAh/g for at least 60 cycles.

15. An anode comprising the coated porous silicon of claim 1.

16. The anode of claim 15, wherein said anode comprising the coated porous silicon of claim 14.

17. The anode of claim 1, wherein said coated porous silicon is crushed, bound with a matrix material and shaped to form an anode; or said coated porous silicon is used as is or is lifted off bulk silicon and used on a optional substrate with an optional transition layer that is optionally doped.

18. A rechargeable battery comprising an anode containing the coated porous silicon of claim 1.

19. The rechargeable battery of claim 18, wherein said rechargeable batter comprising an anode containing the coated porous silicon of claim 14.

20. The rechargeable battery of claim 18, wherein said rechargeable battery comprising said anode comprising the coated porous silicon of claim 1 overlayed on top of an optional substrate, an optional transition layer between said coated porous silicon and said substrate, a separator and a cathode material.

21. The rechargeable battery of claim 20, wherein said substrate is selected from the group consisting of copper, bulk silicon, carbon, silicon carbide, carbon, graphite, carbon fibers, graphene sheets, fullerenes, carbon nanotubes, and graphene platelets and combinations thereof.

22. The rechargeable battery of claim 18, wherein said rechargeable battery further comprising a separator and a cathode material, wherein said battery can be packaged in a coil-cell, pouch cell, cylindrical cell, or a prismatic cell configuration.
